(19) United States
(12) Patent Application Publication
(10) Pub. No.: US 2026/0168291 A1
(43) Pub. Date: Jun. 18, 2026

(54) MULTI-TOOL DEVICE FOR LAW ENFORCEMENT

(71) Applicant: Evidence Tools Company, Inc., Severna Park, MD (US)

(72) Inventors: Chase Alexander Lawson, Severna Park, MD (US); Michael Joseph Mahon, Severna Park, MD (US); Robert Stewart McKeeman, Fort Lauderdale, FL (US)

(21) Appl. No.: 19/424,549

(22) Filed: Dec. 18, 2025

Related U.S. Application Data
(60) Provisional application No. 63/735,579, filed on Dec. 18, 2024.

(51) Int. Cl. E05B 75/00; E05B 17/10

(52) U.S. Cl. CPC E05B 75/00; E05B 17/103

(57) ABSTRACT

Various implementations include a multi-tool device for use in law enforcement. The device includes a body having a longitudinal axis, a first body end, and a second body end opposite and spaced apart along the longitudinal axis from the first body end. The device includes a handcuff lock tool coupled to the first body end. The lock tool includes a handcuff key. The device includes a fingertip element coupled to one of the first body end or the second body end.

### BACKGROUND

Law enforcement officers often utilize handcuffs to restrain detainees. However, law enforcement officers must carry additional items related to handcuffs in order to use the handcuffs as intended and in a safe way.

Once handcuffs are closed in a locked configuration around the wrist of a detainee, the handcuffs must be unlocked in order to be removed. A handcuff key is specially designed to engage the locking mechanism of the handcuffs to move the handcuffs from a locked configuration to an unlocked configuration. Thus, a law enforcement officer must carry a handcuff key to unlock the handcuffs.

Furthermore, some handcuffs include a double locking mechanism that, when in the double locked configuration, cannot be unlocked using just the handcuff key. To move the handcuffs from the double locked configuration to the double unlocked configuration, a double lock tip or end effector must be used to engage the double locking mechanism. Once in the double unlocked configuration, the handcuff can be used as described above to move the handcuffs to the unlocked configuration. Thus, a law enforcement officer must also carry a double lock tip or end effector or carry a handcuff key that includes a double lock tip or end effector, to unlock the handcuffs.

When the handcuffs are closed around a detainee's wrists, the tightness of the handcuffs must also be checked for the detainee's safety. Current practice is for an officer to insert their pinky-finger between the detainee's wrist and the closed handcuff. If the officer's pinky-finger does not fit, then the handcuffs are too tight and could cause a safety issue for the detainee. However, placing the officer's finger between the handcuff and the detainee's wrist can create a dangerous situation for the officer as well. A quick movement by the detainee while the officer's finger is trapped can cause injury to the officer and could cause the officer to be unable to move a safe distance away from the detainee. Thus, if the officer does not want to use their finger to test the tightness of the handcuffs, then the officer must also carry a wand that is the same or a similar size as their finger that can be used instead.

### SUMMARY

Various implementations include a multi-tool device for use in law enforcement. The device includes a body having a longitudinal axis, a first body end, and a second body end opposite and spaced apart along the longitudinal axis from the first body end. The device includes a handcuff lock tool coupled to the first body end. The lock tool includes a handcuff key. The device includes a fingertip element coupled to one of the first body end or the second body end.

In some implementations, the handcuff lock tool is rotationally coupled to the first body end. In some implementations, the handcuff lock tool includes a first lock end and a second lock end opposite and spaced apart from the first lock end. In some implementations, the handcuff key is coupled to the first lock end and a double lock tip is coupled to the second lock end. In some implementations, the handcuff lock tool is rotatable between a key position and a lock tip position. In some implementations, the handcuff key extends away from the first body end and the double lock tip is disposed within the body in the key position. In some implementations, the double lock tip extends away from the first body end and the handcuff key is disposed within the body in the lock tip position.

In some implementations, the device further includes a locking mechanism including a spring-pin and at least one detent defined by the handcuff lock tool. In some implementations, the locking mechanism is biased toward a locked position in which the spring-pin engages the at least one detent and is urgable toward an unlocked position in which the spring-pin is not engaged with the at least one detent. In some implementations, the locking mechanism includes a slider coupled to the spring pin and extending outwardly from a side of the body. In some implementations, the slider is movable to cause the spring-pin to move from the locked position toward the unlocked position. In some implementations, the device further includes an axel about which the handcuff lock tool is rotatable relative to the body. In some implementations, the at least one detent is defined by a portion of the axel. In some implementations, the at least one detent includes two detents.

In some implementations, the fingertip element includes silicone. In some implementations, the fingertip element is coupled to the second body end. In some implementations, the fingertip element is removably coupled to the second body end.

In some implementations, the device further includes a light source configured to emit light through the fingertip element. In some implementations, the light source is configured to emit light at 10 lumens or less. In some implementations, the light source is configured to emit light in a strobing pattern.

In some implementations, the device further includes a transmitter. In some implementations, activation of the light source transmits a signal configured to cause a camera external to the device to initiate recording.

In some implementations, the device further includes a writing instrument extending from the second body end such that the fingertip element covers at least a portion of the writing instrument when coupled to the second body end.

In some implementations, the device further includes a distance test indicator. In some implementations, the distance test indicator includes a hall effect sensor or a magnet. In some implementations, the distance test indicator includes a Near Field Communication (NFC) module configured to emit a proximity signal.

In some implementations, the device further includes a controller having a processor and a system memory. In some implementations, the processor is in operative communication with the distance test indicator. In some implementations, the processor executes computer-readable instructions stored on the system memory. In some implementations, the instructions cause the processor to cause the system memory to receive a distance input from the distance test indicator. In some implementations, the instructions cause the processor to compare the distance input to a predetermined distance threshold. In some implementations, the instructions cause the processor to generate a distance signal if the distance input is above the predetermined distance threshold.

In some implementations, the instructions further cause the processor to cause the device to provide a visual feedback, an audible feedback, or a haptic feedback.

In some implementations, the device further includes a transmitter configured to transmit the distance signal externally from the device. In some implementations, the distance signal is encrypted. In some implementations, the distance signal includes a timestamp or data specific to the device.

In some implementations, the device further includes a pressure sensor, an oxygen saturation sensor, or a pulse sensor.

In some implementations, the fingertip element is removably coupled to the first body end such that the fingertip element covers at least a portion of the handcuff lock tool when coupled to the first body end. In some implementations, the device further includes a double lock tip extending from the body.

### BRIEF DESCRIPTION OF DRAWINGS

Example features and implementations of the present disclosure are disclosed in the accompanying drawings. However, the present disclosure is not limited to the precise arrangements and instrumentalities shown. Similar elements in different implementations are designated using the same reference numerals.

FIG. 1 is a perspective view of a multi-tool device for use in law enforcement, according to one implementation.

FIG. 2 is a side cross-sectional view of the multi-tool device shown in FIG. 1.

FIG. 3 is a front view of the multi-tool device shown in FIG. 1.

FIG. 4 is a perspective view of the multi-tool device shown in FIG. 1 with a fingertip element removed.

FIG. 5 is a cross-sectional view of the multi-tool device shown in FIG. 1.

FIG. 6 is a perspective cross-sectional view of the multi-tool device shown in FIG. 1.

FIG. 7 is an isometric view of a handcuff lock tool of the multi-tool device shown in FIG. 1.

FIG. 8 is a side view of the handcuff lock tool of the multi-tool device shown in FIG. 1.

FIG. 9 is a cross-sectional view of the multi-tool device shown in FIG. 1.

FIG. 10 is a side view of a multi-tool device for use in law enforcement, according to another implementation.

FIG. 11 is a side view of a multi-tool device for use in law enforcement, according to another implementation.

FIG. 12 is a side view of the multi-tool device shown in FIG. 11 with a fingertip element coupled to a handcuff key.

### DETAILED DESCRIPTION

Law enforcement officers carry multiple tools related to the use of handcuffs, including handcuff keys, double lock tips or end effectors, and spacing verification devices. Carrying these tools separately can increase the weight and complexity of an officer's equipment and can reduce organization. A multi-tool device for use in law enforcement may consolidate a plurality of these tools into a single device, thereby reducing the total number of separate items an officer carries.

The multi-tool device may include a body, a handcuff lock tool, and a fingertip element. The body may serve as a housing for various components and may provide a structure to which other elements of the multi-tool device are coupled. The handcuff lock tool may be configured to interact with handcuff locking mechanisms. The fingertip element may be configured to act as a physical spacer for verifying proper handcuff fitment on a detainee's wrist.

By integrating multiple functions into a single multi-tool device, an officer may benefit from weight reduction, reduced complexity, and increased organization of the tools being carried. The multi-tool device may be sized and shaped for convenient carrying on an officer's person, such as in a pocket or clipped to a belt or uniform.

Various implementations include a multi-tool device for use in law enforcement. The device includes a body having a longitudinal axis, a first body end, and a second body end opposite and spaced apart along the longitudinal axis from the first body end. The device includes a handcuff lock tool coupled to the first body end. The lock tool includes a handcuff key. The device includes a fingertip element coupled to one of the first body end or the second body end.

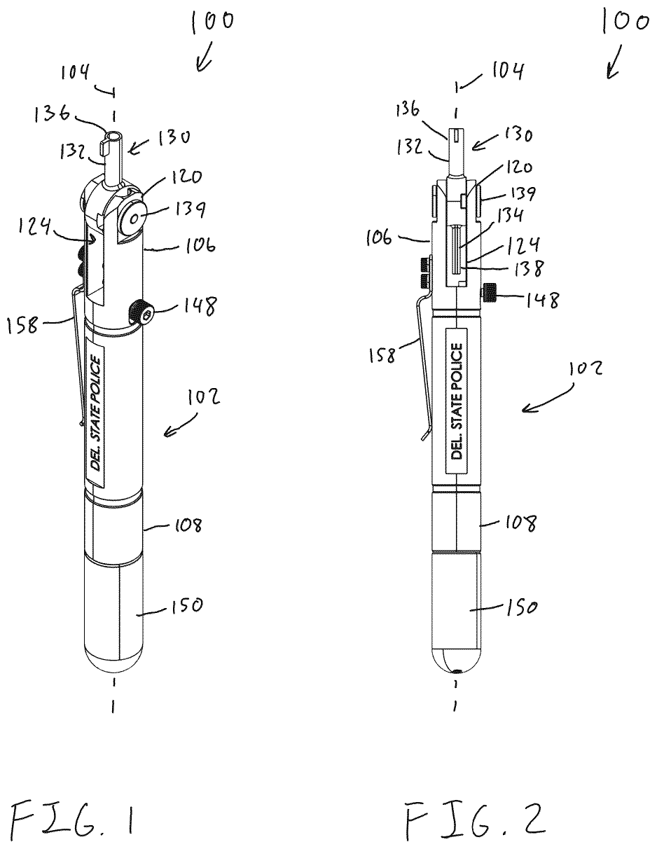

FIGS. 1-9 show a multi-tool device 100 for use in law enforcement including a body 102, a handcuff lock tool 130, a fingertip element 150, an various electronic elements.

Referring to FIG. 1, the multi-tool device 100 for use in law enforcement includes a body 102 having a longitudinal axis 104, a first body end 106, and a second body end 108 opposite and spaced apart along the longitudinal axis 104 from the first body end 106. The body 102 has an elongated, generally cylindrical shape that extends between the first body end 106 and the second body end 108. A handcuff lock tool 130 is coupled to the first body end 106 and extends outward from the first body end 106. The handcuff lock tool 130 includes a handcuff key 132 configured to engage handcuff locking mechanisms. A fingertip element 150 is coupled to the second body end 108 and provides a soft, rounded end that extends away from the second body end 108. The fingertip element 150 is configured to be inserted between a detainee's wrist and a handcuff to verify proper spacing. A pocket clip 158 is attached to an exterior surface of the body 102 and is positioned to allow the multi-tool device 100 to be secured to a user's clothing or equipment, such as a belt, pocket, or uniform.

With continued reference to FIG. 1, and referring also to FIG. 2, the multi-tool device 100 presents a compact, integrated tool that consolidates multiple law enforcement implements into a single portable device. The body 102 serves as a housing for various internal components and provides a structure to which the handcuff lock tool 130, the fingertip element 150, and the pocket clip 158 are coupled. The elongated shape of the body 102 allows the multi-tool device 100 to be conveniently carried on an officer's person.

Referring to FIG. 3, a front view of the multi-tool device 100 shows the body 102 extending vertically along the longitudinal axis 104. The handcuff lock tool 130 is visible at an upper end of the multi-tool device 100, with the handcuff key 132 projecting away from the first body end 106. The fingertip element 150 is visible at a lower end of the multi-tool device 100, extending downward from the second body end 108 and terminating in a rounded tip. The proportions of the multi-tool device 100 allow the multi-tool device 100 to be comfortably held and operated with one hand.

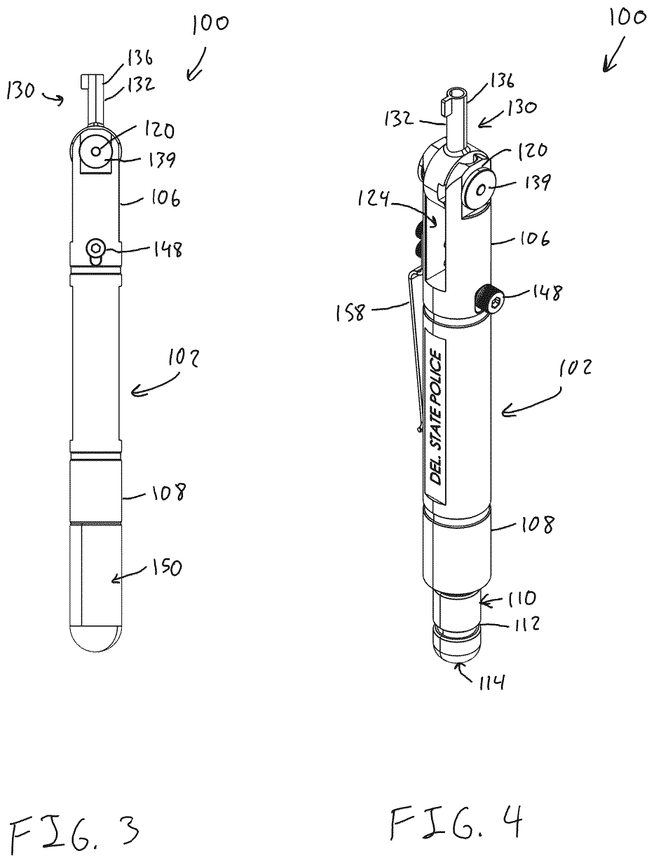

Referring to FIG. 4, a perspective view of the multi-tool device 100 shows the body 102 with the handcuff lock tool 130 extending outward from the first body end 106. The pocket clip 158 is mounted on a side of the body 102 near the first body end 106. The second body end 108 includes a retention head 110 that extends outward from the body 102. In some implementations, the fingertip element 150 is coupled to the retention head 110 at the second body end 108. In some implementations, the fingertip element 150 is coupled to the first body end 106 instead of the second body end 108.

In some implementations, the body 102 of the multi-tool device 100 has a shape other than a generally cylindrical form. The body 102 may have any elongated shape suitable for housing internal components and providing a structure for coupling the handcuff lock tool 130 and the fingertip element 150. In some implementations, the pocket clip 158 is positioned at a location other than near the first body end 106, such as along a middle portion of the body 102 or near the second body end 108.

Referring to FIG. 3, a front view of the multi-tool device 100 illustrates the elongated body 102 extending vertically along the longitudinal axis 104 between the first body end 106 and the second body end 108. At the upper end of the multi-tool device 100, a rotating lock tool assembly is coupled to the first body end 106. The lock tool 130 comprises a handcuff key 132 and a double lock tip 134 at an end opposite the handcuff key 132. The lock tool 130 is rotatable between a key position in which the handcuff key 132 extends away from the first body end 106 and a lock tip position in which the double lock tip 134 extends away from the first body end 106.

The handcuff key 132 projects away from the body 102 in a deployed position, with the handcuff key 132 portion configured to engage handcuff locking mechanisms.

With continued reference to FIG. 3, the body 102 of the multi-tool device 100 includes a middle section that continues with a smooth cylindrical profile below the lock tool 130 assembly. At the lower end of the multi-tool device 100, a retention head 110 is coupled to the second body end 108. A fingertip element 150 is coupled to the retention head 110 and has an elongated, finger-like shape that extends downward from the second body end 108. The fingertip element 150 terminates in a rounded tip configured for insertion between a detainee's wrist and a handcuff to verify proper spacing.

As further shown in FIG. 3, the overall design of the multi-tool device 100 presents a compact, integrated tool that consolidates multiple law enforcement implements into a single handheld device. The proportions of the multi-tool device 100 allow the multi-tool device 100 to be comfortably held and operated with one hand. The various functional elements are distributed along the longitudinal axis 104 to provide access to different tools as needed during use.

In some implementations, the fingertip element 150 is formed of silicone or another soft material configured not to harm a person when inserted between the person's wrist and a handcuff. In some implementations, the fingertip element 150 is removably coupled to the retention head 110 to allow replacement of the fingertip element 150.

Referring to FIG. 4, a perspective view of the multi-tool device 100 shows the body 102 with the handcuff lock tool 130 extending outward from the first body end 106. The second body end 108 includes a retention head 110 that extends outward from the body 102 without a fingertip element 150 coupled to the retention head 110. The retention head 110 is exposed in this view, revealing the structure configured to receive and retain the fingertip element 150. The retention head 110 includes an annular groove 112 configured to receive an inwardly extending flange 156 located on an inner surface of the opening of the fingertip element 150. The body 102 includes visible mounting features near the first body end 106, including a pivot opening 120 and a ball spring mechanism opening 122 on a side of the body 102. The pivot opening 120 and the ball spring mechanism opening 122 facilitate the rotational coupling and retention of the lock tool 130 in various positions. A pocket clip 158 is mounted on a side of the body 102, allowing the multi-tool device 100 to be secured to a belt, pocket, or other carrying location.

With continued reference to FIG. 4, the retention head 110 at the second body end 108 defines an annular groove 112. The fingertip element 150 is coupled to the retention head 110 via an inwardly extending flange 156 that engages the complementary radially extending groove on the retention head 110. The engagement between the flange 156 of the fingertip element 150 and the groove 112 of the retention head 110 retains the fingertip element 150 on the retention head 110. The fingertip element 150 is removably coupled to the second body end 108 such that the fingertip element 150 can be removed from the retention head 110 by applying force to the fingertip element 150 to cause the soft, resilient flange 156 to deform and disengage from the groove 112 of the retention head 110. The removable coupling allows the fingertip element 150 to be replaced when worn or damaged.

In some implementations, the retention head 110 defines a flashlight opening 114 through which light from a light source disposed within the body 102 can be projected. In some implementations, the fingertip element 150 is formed of a transparent or translucent material such that light from the light source can shine through the fingertip element 150. In some implementations, the retention head 110 is formed of a transparent or translucent material. In some implementations, the fingertip element 150 includes a central opening 154 at a distal end through which light from the light source can be projected. In some implementations, the retention head 110 is configured to receive fingertip elements 150 of different sizes or shapes to accommodate different spacing verification requirements.

Referring to FIG. 5, a cross-sectional view of the multi-tool device 100 reveals the internal construction and components housed within the elongated cylindrical body 102. The body 102 extends along the longitudinal axis 104 from the first body end 106 to the second body end 108. At the first body end 106, a lock tool 130 assembly is rotatably coupled to the body 102. The lock tool 130 includes a handcuff key 132 extending outward from the first body end 106 and a double lock tip 134 positioned within the body 102. The lock tool 130 is rotationally coupled to the body 102 through a pivot pin 139 that extends perpendicular to the longitudinal axis 104 through the body 102 and through the lock tool 130. The first body end 106 defines a first cavity 124, and the lock tool 130 is partially disposed within the first cavity 124.

With continued reference to FIG. 5, a spring pin mechanism 140 is positioned adjacent to the pivot pin 139. The spring pin mechanism 140 includes a spring 142 and a pin 144 coupled to an end of the spring 142. The pin 144 is biased partially into the first cavity 124 in a resting state. The pin 144 engages a detent 146 in the lock tool 130 to retain the lock tool 130 in a selected rotational position. When force is applied to the lock tool 130 to rotate the lock tool 130, the pin 144 is urged out of the first cavity 124 as the spring 142 is compressed, allowing the lock tool 130 to rotate. When the lock tool 130 reaches a new rotational position, the pin 144 engages another detent 146 to retain the lock tool 130 in the new position.

As further shown in FIG. 5, the internal cavity of the body 102 contains various electronic components. A flashlight 160 assembly is disposed within the body 102, including a light source and associated circuitry. Additional electronic components are positioned within the body 102, including a battery 162, a controller 164, memory 166, communication modules or transmitter 168 for both hardline and wireless transmission, a charging port, and sensor components. A speaker 178 and antenna 180 elements are also positioned within the body 102.

At the second body end 108, a retention head 110 extends outward from the body 102. The retention head 110 defines a cavity and includes a radially extending groove for coupling with a fingertip element 150. The retention head 110 defines a flashlight opening 114, and a flashlight 160 body is disposed within the body 102 of the device 100 with a bulb disposed within the flashlight opening 114. The bulb is positioned within the retention head 110 such that light can be projected through the second body end 108 of the device 100. The fingertip element 150 is coupled to the retention head 110 and defines a finger cavity 152. A first finger end of the fingertip element 150 defines a central opening 154 extending into the finger cavity 152. Light from the bulb in the retention head 110 shines through the flashlight opening 114 and out of the central opening 154 at the first finger end of the fingertip element 150. The multi-tool device 100 includes a light source configured to emit light through the fingertip element 150.

Referring to FIG. 6, a perspective cross-sectional view of the multi-tool device 100 shows the body 102 with a knurled or textured surface along a portion of the body 102 to enhance grip. At the first body end 106, the lock tool 130 is rotationally coupled to the body 102, with the handcuff key 132 extending outward from the first body end 106. The lock tool 130 is configured to rotate about a pivot point, allowing either the handcuff key 132 or the double lock tip 134 to be positioned for use. At the second body end 108, the retention head 110 has the fingertip element 150 attached. The fingertip element 150 appears as a rounded, finger-shaped component that extends away from the second body end 108. A pocket clip 158 is mounted on a side of the body 102 near the first body end 106.

Referring to FIG. 7, an isometric view of the handcuff lock tool 130 shows the lock tool 130 assembly in detail. The lock tool 130 includes the handcuff key 132 extending from a first lock end 136 and the double lock tip 134 extending from a second lock end 138. The lock tool 130 is rotatably mounted to the body 102 by the pivot pin 139, allowing the lock tool 130 to pivot between a key position and a lock tip position. The pivot pin 139 acts as an axle about which the lock tool 130 rotates. The pivot pin 139 defines two detents 146. A locking mechanism includes a spring-pin that is biased toward a locked position in which the spring-pin engages at least one of the detents 146. The spring-pin is urgable toward an unlocked position in which the spring-pin is not engaged with the at least one detent 146. The locking mechanism includes a slider 148 coupled to the spring-pin and extending outwardly from a side of the body 102. The slider 148 is movable to cause the spring-pin to move from the locked position toward the unlocked position.

In some implementations, the light source is configured to emit light at 10 lumens or less. In some implementations, the light source is configured to emit light in a strobing pattern to assist in horizontal gaze nystagmus testing during field sobriety tests. In some implementations, the fingertip element 150 and the retention head 110 are formed of transparent or translucent material such that light from the light source can illuminate the fingertip element 150 and the retention head 110. In some implementations, the light source is configured to emit standardized illumination suitable for performing field sobriety tests, meeting predefined standards for brightness, wavelength, and beam shape.

In some implementations, the lock tool 130 includes a ball spring mechanism that releasably engages one or more detents 146, similar to a spring-pin.

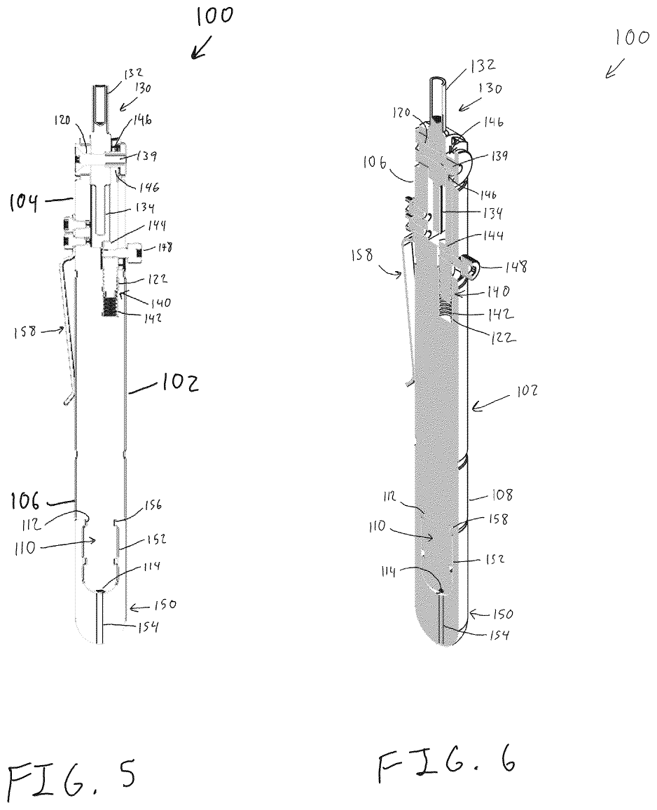

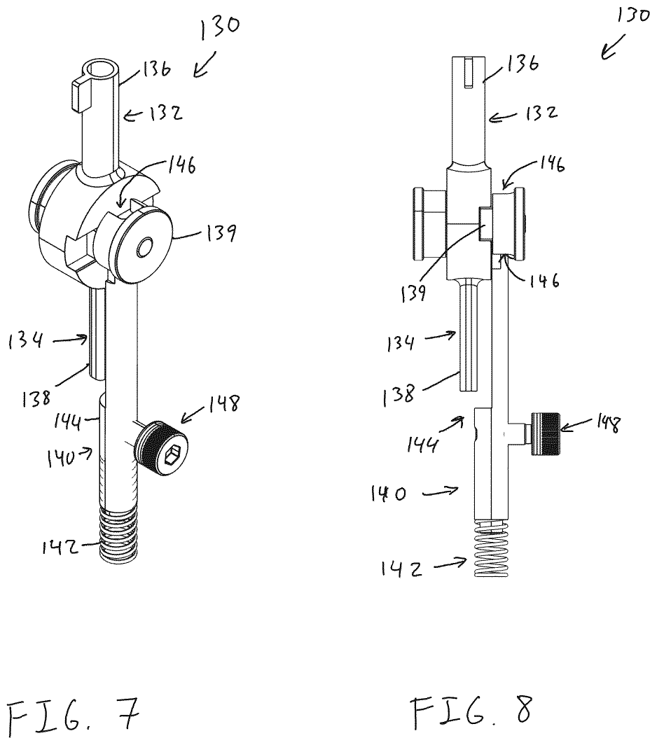

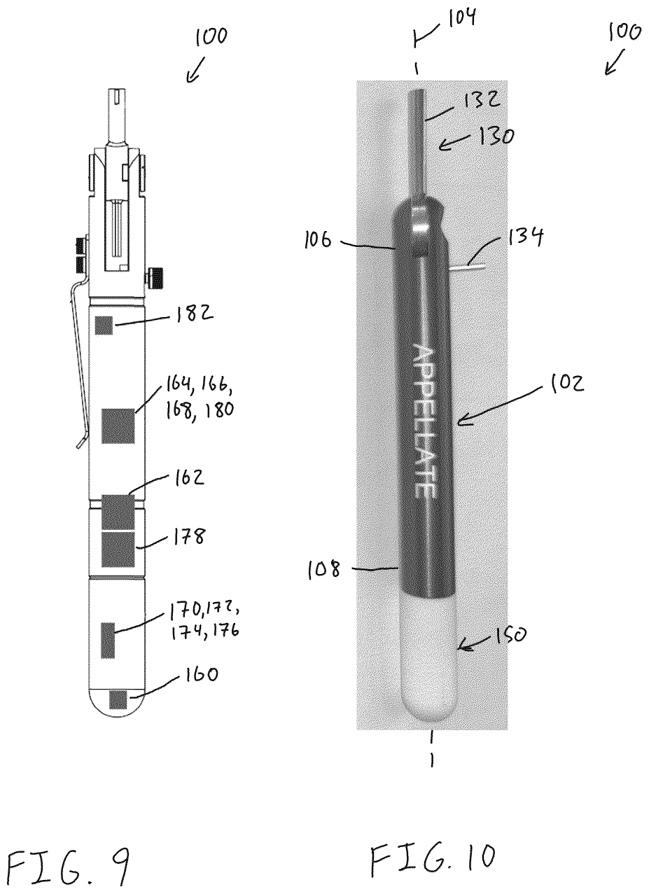

Referring to FIG. 9, a cross-sectional view of the multi-tool device 100 shows the internal arrangement of electronic components housed within the elongated cylindrical body 102. The body 102 extends along the longitudinal axis 104 from the first body end 106 to the second body end 108. At the first body end 106, the lock tool 130 is rotationally coupled to the body 102, with the handcuff key 132 extending outward from the body 102. The lock tool 130 is partially disposed within a cavity at the first body end 106, and a pivot pin 139 extends through the body 102 and the lock tool 130 to allow the lock tool 130 to rotate between positions. A spring pin mechanism 140 is positioned adjacent to the pivot pin 139, with the spring pin mechanism 140 including a spring 142 and a pin 144 that extends into the cavity to engage detents 146 in the lock tool 130.

With continued reference to FIG. 9, the body 102 includes several internal components positioned along the longitudinal axis 104. Near the first body end 106, a light control button 182 is positioned adjacent to the spring pin mechanism 140. The light control button 182 is configured to activate and deactivate a light source disposed within the body 102. A controller 164 is positioned within a middle section of the body 102. The controller 164 includes a processor and a system memory 166. The processor is in operative communication with a distance test indicator 170. The processor executes computer-readable instructions stored on the system memory 166. The instructions cause the processor to cause the system memory 166 to receive a distance input from the distance test indicator 170, compare the distance input to a predetermined distance threshold, and generate a distance signal if the distance input is above the predetermined distance threshold.

As further shown in FIG. 9, a battery 162 is positioned within the body 102 below the controller 164. The battery 162 provides electrical power to the controller 164, the light source, and other electronic components within the multi-tool device 100. A speaker 178 or other audio output device is positioned adjacent to the battery 162. The speaker 178 is configured to provide audible feedback to an officer, such as an audible indication of proper or improper handcuff fitment. Near the second body end 108, a distance test indicator 170 is positioned within the body 102. The distance test indicator 170 is configured to detect proximity to a handcuff or other object. A light source is positioned at the second body end 108 within a retention head 110. The light source is configured to emit light through a fingertip element 150 coupled to the retention head 110.

The controller 164 is operatively connected to the light source and is configured to detect flashlight events. Flashlight events include activation of the light source, deactivation of the light source, movement of the multi-tool device 100 between activation and deactivation, and geographical location of the multi-tool device 100 at the time of activation and deactivation. The geographical location is captured via an integrated GPS module. The multi-tool device 100 includes data storage for storing information related to flashlight events. The data storage stores flashlight events with timestamps.

The multi-tool device 100 includes a transmitter 168 configured to transmit the distance signal externally from the device 100. A communication module is configured to transmit logged events to a remote server or device. The communication module transmits logged events in real time. The communication module transmits information to a secure law enforcement database. The communication module includes wireless transmission capability for transmitting stored operational parameters to an external computing device for evidence logging.

In some implementations, the controller 164 includes memory 166 for storing computer-readable instructions and data related to device operation. In some implementations, the multi-tool device 100 includes communication modules or transmitter 168 for both hardline and wireless transmission. In some implementations, the multi-tool device 100 includes a charging port for recharging the battery 162. In some implementations, the multi-tool device 100 includes sensor components such as a hall effect sensor, a magnet, or a Near Field Communication module. In some implementations, antenna 180 elements are positioned within the body 102 for wireless communication. In some implementations, the audible indicator provides audible feedback in response to detection of proper handcuff spacing or in response to other events detected by the controller 164.

Referring to FIG. 7, an isometric view of the handcuff lock tool 130 shows the lock tool 130 assembly in detail. The handcuff lock tool 130 is rotationally coupled to the first body end 106. The handcuff lock tool 130 includes a first lock end 136 and a second lock end 138 opposite and spaced apart from the first lock end 136. A handcuff key 132 is coupled to the first lock end 136 and extends from the first lock end 136. A double lock tip 134 is coupled to the second lock end 138 and extends from the second lock end 138. The handcuff key 132 and the double lock tip 134 face opposite directions along the handcuff lock tool 130.

With continued reference to FIG. 7, the handcuff lock tool 130 is rotatably mounted to the body 102 by a pivot pin 139. The pivot pin 139 acts as an axel about which the handcuff lock tool 130 is rotatable relative to the body 102. The pivot pin 139 extends perpendicular to the longitudinal axis 104 of the body 102 and passes through the handcuff lock tool 130. The handcuff lock tool 130 is rotatable between a key position and a lock tip position. In the key position, the handcuff key 132 extends away from the first body end 106 and the double lock tip 134 is disposed within the body 102. In the lock tip position, the double lock tip 134 extends away from the first body end 106 and the handcuff key 132 is disposed within the body 102. The rotation of the handcuff lock tool 130 about the pivot pin 139 allows an officer to select which tool extends from the first body end 106 for use.

As further shown in FIG. 7, the pivot pin 139 defines two detents 146. A first detent 146 is located adjacent the first lock end 136, and a second detent 146 is located adjacent the second lock end 138. A locking mechanism comprises a spring-pin and the at least one detent 146 defined by the handcuff lock tool 130. The locking mechanism is biased toward a locked position in which the spring-pin engages the at least one detent 146. The locking mechanism is urgable toward an unlocked position in which the spring-pin is not engaged with the at least one detent 146. The spring-pin engages the first detent 146 when the handcuff lock tool 130 is in the key position. The spring-pin engages the second detent 146 when the handcuff lock tool 130 is in the lock tip position. The engagement of the spring-pin with either detent 146 retains the handcuff lock tool 130 in the current position.

The locking mechanism includes a slider 148 coupled to the spring-pin and extending outwardly from a side of the body 102. The slider 148 is movable to cause the spring-pin to move from the locked position toward the unlocked position. When an officer moves the slider 148, the spring-pin disengages from the detent 146, allowing the handcuff lock tool 130 to rotate freely about the pivot pin 139. When the slider 148 is released, the spring-pin is biased back toward the locked position to engage the detent 146 corresponding to the new rotational position of the handcuff lock tool 130.

In some implementations, the locking plunger is made of AISI 1018 steel. In some implementations, a sprocket key component and a keyed sprocket component of the lock tool 130 assembly are made of AISI 1018 steel. In some implementations, a key bushing is made of AISI 1018 steel. In some implementations, the pivot pin 139 is made of alloy steel. In some implementations, the spring-pin is biased by a compression spring 142 made of music-wire steel. In some implementations, the handcuff lock tool 130 includes additional detent 146 positions for intermediate rotational positions between the key position and the lock tip position.

Referring to FIG. 8, a side view of the handcuff lock tool 130 shows the lock tool 130 assembly with the slider 148 extending outwardly from a side of the body 102. The handcuff lock tool 130 includes the handcuff key 132 extending from the first lock end 136 and the double lock tip 134 extending from the second lock end 138. The lock tool 130 is rotatably mounted to the body 102 by the pivot pin 139, which acts as an axle about which the lock tool 130 rotates between the key position and the lock tip position. The pivot pin 139 defines two detents 146 that correspond to the key position and the lock tip position.

With continued reference to FIG. 8, the locking mechanism includes the slider 148 coupled to the spring-pin and extending outwardly from a side of the body 102. The slider 148 is positioned on an exterior surface of the body 102 such that an officer can access and manipulate the slider 148 with a finger or thumb while holding the multi-tool device 100. The slider 148 is movable to cause the spring-pin to move from the locked position toward the unlocked position. When the slider 148 is moved in a direction away from the body 102, the spring-pin is pulled out of engagement with the detent 146, allowing the handcuff lock tool 130 to rotate freely about the pivot pin 139. When the slider 148 is released, the spring-pin is biased back toward the locked position by the compression spring 142, causing the spring-pin to engage the detent 146 corresponding to the new rotational position of the handcuff lock tool 130.

As further shown in FIG. 8, the compression spring 142 biases the spring-pin toward the locked position. The compression spring 142 is made of music-wire steel. The pivot mechanism uses an alloy steel shoulder screw that extends through the body 102 and through the handcuff lock tool 130 to provide the rotational coupling.

In some implementations, the slider 148 is positioned at a different location on the body 102, such as on a top surface or a bottom surface of the body 102. In some implementations, the slider 148 is recessed within a channel or groove in the body 102 to prevent inadvertent actuation. In some implementations, the slider 148 includes a textured surface to enhance grip during manipulation. In some implementations, the compression spring 142 is made of a material other than music-wire steel. In some implementations, the pivot mechanism uses a pin or shaft made of a material other than alloy steel. In some implementations, the screws used for assembly are made of stainless steel or another corrosion-resistant material. In some implementations, the locking mechanism includes a button instead of a slider 148, wherein the button is depressible to cause the spring-pin to move from the locked position toward the unlocked position.

Referring to FIG. 9, a cross-sectional view of the multi-tool device 100 shows the internal arrangement of components positioned within the elongated cylindrical body 102 along the longitudinal axis 104. At the first body end 106, the lock tool 130 is rotationally coupled to the body 102, with the handcuff key 132 extending outward from the body 102. A pivot pin 139 extends through the body 102 and the lock tool 130, and a spring pin mechanism 140 is positioned adjacent to the pivot pin 139 to retain the lock tool 130 in selected rotational positions.

With continued reference to FIG. 9, a light control button 182 is positioned near the first body end 106, adjacent to the spring pin mechanism 140. The light control button 182 is disposed on a side of the body 102 and is configured to activate and deactivate a light source disposed within the body 102. The light control button 182 is also configured to initiate wireless communication of stored evidence data to a paired mobile device, a centralized database, or handcuffs equipped with sensors. One or more buttons on the body 102 of the multi-tool device 100 are used for activating and deactivating the flashlight 160 and initiating wireless communication of stored evidence data.

As further shown in FIG. 9, a controller 164 is positioned within a middle section of the body 102. The controller 164 includes a processor and a system memory 166. The processor is in operative communication with a distance test indicator 170 and with the light source. The processor executes computer-readable instructions stored on the system memory 166. A battery 162 is positioned within the body 102 below the controller 164. The battery 162 provides electrical power to the controller 164, the light source, and other electronic components within the multi-tool device 100. A speaker 178 or other audio output device is positioned adjacent to the battery 162. The speaker 178 is configured to provide audible feedback to an officer.

With continued reference to FIG. 9, a distance test indicator 170 is positioned within the body 102 near the second body end 108. The distance test indicator 170 is configured to detect proximity to a handcuff or other object and to provide a distance input to the controller 164. The distance test indicator 170 can comprise a hall effect sensor or a magnet. The hall effect sensor detects the presence of a magnetic field, such as a magnetic field generated by a magnet embedded in a handcuff. The distance test indicator 170 can comprise a Near Field Communication (NFC) module configured to emit a proximity signal. The NFC module emits a proximity signal detectable by a sensor in a handcuff when the multi-tool device 100 is brought within a predefined range of the handcuff.

As further shown in FIG. 9, a light source is positioned at the second body end 108 within a retention head 110. The light source is configured to emit light through a fingertip element 150 coupled to the retention head 110. The fingertip element 150 is coupled to the second body end 108 and has a rounded end configured for insertion between a detainee's wrist and a handcuff to verify proper spacing.

The multi-tool device 100 provides positive indication of proper or safe handcuff fitment by audible feedback, visual feedback, vibration feedback, or a combination thereof. The instructions stored on the system memory 166 cause the processor to cause the device 100 to provide a visual feedback, an audible feedback, or a haptic feedback. The audible feedback is provided by the speaker 178 or audio output device. The visual feedback is provided by the light source or by another indicator light disposed within the body 102. The haptic feedback is provided by a vibration motor disposed within the body 102 or the speaker 178. The feedback is provided to the officer or to an officer's body camera as a means to ensure safety and create a log of evidence.

In some implementations, the distance test indicator 170 comprises a magnet instead of a hall effect sensor, wherein the magnet is embedded in the multi-tool device 100 and a hall effect sensor is embedded in the handcuff. In some implementations, the distance test indicator 170 comprises both a hall effect sensor and a magnet. In some implementations, the NFC module includes an encryption protocol to prevent unauthorized activation or duplication of the proximity signal. In some implementations, the distance test indicator 170 comprises an RFID transceiver configured to communicate with an RFID tag embedded in a handcuff. In some implementations, the distance test indicator 170 comprises a combination of a hall effect sensor, a magnet, and an NFC module. In some implementations, the feedback provided to the officer includes a confirmation code indicating that the handcuffs were double-locked at the time of verification. In some implementations, the feedback is transmitted wirelessly to an officer's body camera to initiate recording or to tag recorded video with verification data.

Referring to FIG. 10, a multi-tool device 100 for use in law enforcement according to another embodiment features an elongated cylindrical body 102. The body 102 extends along a longitudinal axis 104 from a first body end 106 to a second body end 108. At the first body end 106, a lock tool 130 extends outward from the body 102. The lock tool 130 includes a handcuff key 132 component configured to engage handcuff locking mechanisms. A small pin or projection extends laterally from the body 102 near the first body end 106, which serves as part of a double lock tip 134 mechanism.

With continued reference to FIG. 10, the fingertip element 150 is coupled to the second body end 108. The fingertip element 150 has a rounded, bulbous shape configured to be inserted between a detainee's wrist and a handcuff to verify proper spacing. The fingertip element 150 is formed of silicone. The silicone material of the fingertip element 150 is soft enough not to harm a person when inserted between the person's wrist and a handcuff. The rounded shape of the fingertip element 150 allows the fingertip element 150 to be inserted and removed from between the detainee's wrist and the handcuff without causing discomfort or injury to the detainee.

As further shown in FIG. 10, the overall design presents a compact, integrated tool that consolidates multiple law enforcement functions into a single handheld device. The silicone fingertip element 150 on the lower portion provides a soft, compliant surface for contact with a detainee's skin during spacing verification.

In some implementations, the fingertip element 150 is made of Nylon 12 material or any other soft material. In some implementations, the fingertip element 150 is made of rubber, thermoplastic elastomer, or another soft polymer material. In some implementations, the fingertip element 150 is made of any material soft enough not to harm a person when inserted between the person's wrist and a handcuff. In some implementations, the body 102 is made of anodized aluminum, stainless steel, or another durable metallic material. In some implementations, the body 102 is made of a polymer material with a metallic coating or finish.

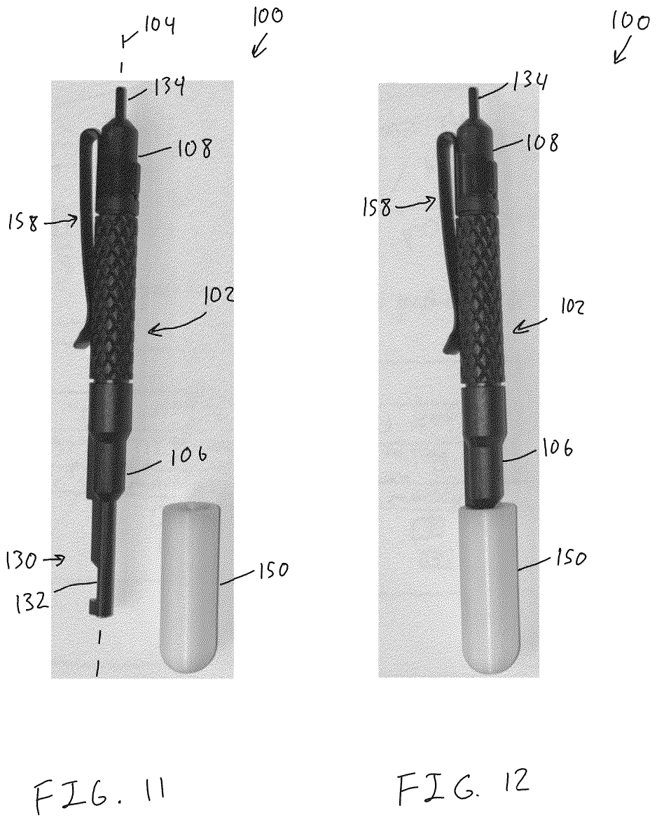

Referring to FIG. 11, a multi-tool device 100 for use in law enforcement according to another embodiment features a non-rotatable lock tool 130 configuration. The multi-tool device 100 has an elongated, generally cylindrical body 102 with a longitudinal axis 104 extending between a first body end 106 and a second body end 108 opposite and spaced apart from the first body end 106. A handcuff lock tool 130 is coupled to the first body end 106. The handcuff lock tool 130 includes a handcuff key 132 that is fixed mounted at the first body end 106 rather than rotatably coupled to the body 102. The handcuff key 132 extends outward from the first body end 106 and features a cylindrical shaft with a specialized tip configured to engage handcuff locking mechanisms.

With continued reference to FIG. 11, a double lock tip 134 extends from the second body end 108 of the body 102. The double lock tip 134 is fixed mounted orthogonal to the handle rather than rotatably coupled to the body 102. The double lock tip 134 is configured to engage double locking mechanisms of handcuffs to move the handcuffs from a double locked configuration to a double unlocked configuration. The fixed mounting of the double lock tip 134 at the second body end 108 positions the double lock tip 134 at an opposite end of the multi-tool device 100 from the handcuff key 132 at the first body end 106.

As further shown in FIG. 11, a central portion of the body 102 includes a textured grip surface with a knurled or diamond-pattern finish. The textured grip surface enhances user grip during operation of the multi-tool device 100. The textured section provides a secure holding area for a user's hand when manipulating the handcuff key 132 or the double lock tip 134.

With continued reference to FIG. 11, a fingertip element 150 is removably coupled to the first body end 106 such that the fingertip element 150 covers at least a portion of the handcuff lock tool 130 when coupled to the first body end 106. The fingertip element 150 defines an opening shaped to accept the specialized tip of the handcuff key 132. The fingertip element 150 appears as a cylindrical component that extends away from the first body end 106 when coupled to the handcuff key 132. The fingertip element 150 is sized and configured to be inserted between a detainee's wrist and a handcuff to verify proper spacing and ensure the handcuffs are not over-tightened. The fingertip element 150 functions as a locking cap designed to cover the key end of the handcuff key 132, where the cap doubles as a pinky alternative for checking handcuff spacing.

As further shown in FIG. 11, when the fingertip element 150 is rotated relative to the handcuff key 132, the opening within the fingertip element 150 locks the larger specialized tip onto the handcuff key 132. The shaped opening within the fingertip element 150 engages with the specialized tip of the handcuff key 132 to retain the fingertip element 150 on the handcuff key 132 during use. The fingertip element 150 is removable from the handcuff key 132 by rotating the fingertip element 150 to disengage the opening from the specialized tip and then pulling the fingertip element 150 away from the first body end 106.

A pocket clip 158 is attached to a side of the body 102 near the first body end 106. The pocket clip 158 allows the multi-tool device 100 to be secured to a user's pocket or belt for convenient carrying. The overall design integrates multiple law enforcement tools into a single, compact device that is carried and accessed by officers in the field.

In some implementations, the handcuff key 132 and the double lock tip 134 are configured in a mix of fixed, retractable, or deployable configurations. In some implementations, the handcuff key 132 is retractable or rotatable into the body 102 when not in use. In some implementations, the double lock tip 134 is deployable from a stored position within the body 102 to an extended position for use. In some implementations, the handcuff key 132 is fixed mounted and the double lock tip 134 is rotatable. In some implementations, the double lock tip 134 is fixed mounted and the handcuff key 132 is retractable or rotatable. In some implementations, both the handcuff key 132 and the double lock tip 134 are deployable from stored positions within the body 102. In some implementations, the fingertip element 150 is coupled to the second body end 108 instead of the first body end 106. In some implementations, the fingertip element 150 is formed of silicone, rubber, thermoplastic elastomer, or another soft polymer material. In some implementations, the textured grip surface extends along a greater or lesser portion of the body 102. In some implementations, the textured grip surface has a pattern other than a knurled or diamond pattern, such as a ribbed pattern, a stippled pattern, or a checkered pattern.

Referring to FIG. 12, the multi-tool device 100 for law enforcement is shown with the fingertip element 150 coupled to the handcuff key 132 of the lock tool 130 at the first body end 106. The fingertip element 150 is positioned over the handcuff key 132 such that the fingertip element 150 covers at least a portion of the handcuff lock tool 130. The fingertip element 150 extends away from the first body end 106 in an orientation aligned with the handcuff key 132.

With continued reference to FIG. 12, the fingertip element 150 defines an opening shaped to accept the specialized tip of the handcuff key 132. The opening within the fingertip element 150 has a profile that corresponds to the shape of the specialized tip of the handcuff key 132. When the fingertip element 150 is placed over the handcuff key 132, the specialized tip of the handcuff key 132 is received within the opening of the fingertip element 150. The shaped opening engages with the specialized tip to provide a mechanical connection between the fingertip element 150 and the handcuff key 132.

As further shown in FIG. 12, when the fingertip element 150 is rotated relative to the handcuff key 132, the opening within the fingertip element 150 locks the larger specialized tip onto the handcuff key 132. The rotation of the fingertip element 150 causes the shaped opening to engage with corresponding features on the specialized tip, thereby retaining the fingertip element 150 on the handcuff key 132. The locking engagement prevents the fingertip element 150 from inadvertently separating from the handcuff key 132 during use. The fingertip element 150 appears as a cylindrical component that extends away from the first body end 106 when coupled to the handcuff key 132.

With continued reference to FIG. 12, the fingertip element 150 is sized and configured to be inserted between a detainee's wrist and a handcuff to verify proper spacing and ensure the handcuffs are not over-tightened. The fingertip element 150 acts as a physical spacer with predefined dimensions to enforce a minimum spacing standard between the detainee's wrist and the inner surface of the handcuffs. The fingertip element 150 provides an alternative to using an officer's physical pinky finger to check handcuff spacing, thereby reducing the risk of injury to the officer from sudden movements by the detainee.

The fingertip element 150 is removably coupled to the handcuff key 132 at the first body end 106. To remove the fingertip element 150 from the handcuff key 132, the fingertip element 150 is rotated in a direction opposite to the locking direction to disengage the opening from the specialized tip. Once the opening is disengaged from the specialized tip, the fingertip element 150 is pulled away from the first body end 106 to separate the fingertip element 150 from the handcuff key 132. The removable coupling allows the fingertip element 150 to be attached to the handcuff key 132 when spacing verification is needed and removed when access to the handcuff key 132 for unlocking handcuffs is needed.

In some implementations, the fingertip element 150 is formed of silicone, rubber, thermoplastic elastomer, Nylon 12, or another soft polymer material. In some implementations, the fingertip element 150 is formed of a material soft enough not to harm a person when inserted between the person's wrist and a handcuff. In some implementations, the opening within the fingertip element 150 has a bayonet-style configuration that locks upon partial rotation. In some implementations, the opening within the fingertip element 150 has a threaded configuration that locks upon full rotation. In some implementations, the fingertip element 150 includes visual markings or indicators to show when the fingertip element 150 is locked onto the handcuff key 132. In some implementations, the fingertip element 150 includes a detent or click mechanism that provides tactile feedback when the fingertip element 150 is locked onto the handcuff key 132. In some implementations, the fingertip element 150 is configured to be coupled to the second body end 108 instead of the first body end 106. In some implementations, the multi-tool device 100 includes multiple fingertip elements 150 of different sizes to accommodate different spacing verification requirements.

The multi-tool device 100 includes a light source disposed within the body 102 and configured to emit light through the fingertip element 150. The light source is configured to emit light at 10 lumens or less. The light output at 10 lumens or less provides illumination suitable for close-range tasks such as checking handcuff fitment and performing field sobriety tests without causing discomfort or temporary blindness to a detainee or subject being tested.

The light source can be configured to emit light in a strobing pattern. The strobing pattern assists in horizontal gaze nystagmus testing during field sobriety tests. Horizontal gaze nystagmus testing involves observing the involuntary jerking of a subject's eyes as the eyes follow a moving stimulus. The strobing pattern of the light source provides a visual stimulus that an officer moves across the subject's field of vision while observing the subject's eye movements for signs of impairment.

The light source is configured to emit standardized illumination suitable for performing field sobriety tests. The standardized illumination meets predefined standards for brightness, wavelength, and beam shape tailored for use in sobriety testing. The predefined standards ensure that the light output is consistent and appropriate for the testing conditions encountered in field sobriety testing environments. The brightness level is set to provide adequate illumination without overwhelming the subject's vision. The wavelength of the emitted light is selected to be visible and trackable by the subject during testing. The beam shape is configured to provide a focused point of light that the subject can follow during horizontal gaze nystagmus testing.

The fingertip element 150 can be made of transparent or translucent material such that light from the light source shines through the fingertip element 150. The transparent or translucent material allows light emitted by the light source to pass through the fingertip element 150 and project outward from the distal end of the fingertip element 150. The retention head 110 can be made of transparent or translucent material such that light from the light source shines through the retention head 110. The transparent or translucent material of the retention head 110 allows light to pass from the light source through the retention head 110 and into the fingertip element 150. The combination of transparent or translucent materials in the retention head 110 and the fingertip element 150 provides a light path from the light source to the exterior of the multi-tool device 100.

The transparent or translucent material of the fingertip element 150 and the retention head 110 allows light from the light source to illuminate the fingertip element 150 and the retention head 110. The illumination of the fingertip element 150 provides visual indication of light source activation and assists in low-light conditions when checking handcuff fitment. The illumination of the retention head 110 provides additional visual feedback to the officer during operation of the multi-tool device 100.

In some implementations, the light source is configured to emit light at a brightness level other than 10 lumens or less, such as between 10 lumens and 50 lumens for applications requiring greater illumination. In some implementations, the light source is configured to emit light in a continuous pattern rather than a strobing pattern. In some implementations, the light source is configured to emit light in both a continuous pattern and a strobing pattern, with the pattern selectable by the officer via the light control button 182. In some implementations, the strobing pattern has a frequency between 1 Hz and 10 Hz. In some implementations, the strobing pattern has a frequency adjustable by the officer. In some implementations, the light source emits light in a wavelength range corresponding to white light. In some implementations, the light source emits light in a wavelength range corresponding to red light, which preserves night vision adaptation. In some implementations, the light source emits light in multiple selectable wavelength ranges.

In some implementations, the fingertip element 150 is made of opaque material and includes a central opening 154 at the distal end through which light from the light source is projected. In some implementations, the retention head 110 is made of opaque material and includes a flashlight opening 114 through which light from the light source is projected into the fingertip element 150. In some implementations, the fingertip element 150 is made of a material that diffuses light from the light source to provide a softer, more evenly distributed illumination. In some implementations, the retention head 110 includes a lens or optical element that focuses or shapes the beam of light emitted by the light source. In some implementations, the beam shape is adjustable between a focused spot and a wider flood pattern. In some implementations, the light source comprises a light-emitting diode. In some implementations, the light source comprises multiple light-emitting diodes configured to emit light at different wavelengths or brightness levels.

The multi-tool device 100 includes a transmitter 168 disposed within the body 102. The transmitter 168 is configured to transmit signals wirelessly to external devices. Activation of the light source transmits a signal configured to cause a camera external to the device 100 to initiate recording. When an officer activates the light source via the light control button 182, the transmitter 168 simultaneously transmits an activation signal to a body-worn camera, a dashboard camera, or another recording device carried by the officer or mounted in a patrol vehicle. The activation signal causes the external camera to begin recording video and audio of the interaction between the officer and a subject. The automatic initiation of recording upon light source activation ensures that field sobriety tests and handcuff fitment checks are documented without requiring the officer to manually activate the recording device.

The transmitter 168 transmits the activation signal using a wireless communication protocol. The wireless communication protocol includes Bluetooth, Wi-Fi, Near Field Communication, or another short-range wireless protocol compatible with law enforcement recording equipment. The transmitter 168 is operatively connected to the controller 164 such that the controller 164 causes the transmitter 168 to transmit the activation signal in response to detection of light source activation. The controller 164 monitors the state of the light source and triggers the transmitter 168 when the light source transitions from a deactivated state to an activated state.

The wireless communication of stored evidence data to handcuffs and a paired mobile device or centralized database occurs automatically after a predetermined amount of time after an event. The controller 164 can include a timer function that tracks elapsed time following detection of an event such as light source activation, distance test indicator 170 activation, or completion of a spacing verification check. When the predetermined amount of time elapses after the event, the controller 164 can cause the transmitter 168 to transmit stored evidence data to the handcuffs, the paired mobile device, or the centralized database without requiring manual initiation by the officer. The automatic transmission ensures that evidence data is uploaded and preserved even if the officer is occupied with other tasks following the event.

The predetermined amount of time can be configurable by a system administrator or by the officer. The predetermined amount of time ranges from immediate transmission upon event completion to transmission after a delay of several minutes. The configurable delay allows departments to balance the need for timely evidence preservation against network bandwidth constraints and operational considerations. The controller 164 stores the predetermined amount of time in the system memory 166 and retrieves the stored value when determining when to initiate automatic transmission.

The transmitter 168 can transmit stored evidence data to a secure evidence management system. The stored evidence data can include one or more of timestamps, distance verification results, device identification information, geographical location data, and flashlight event logs. The transmitter 168 encrypts the stored evidence data prior to transmission to prevent interception or tampering during wireless transmission. The encryption protocol conforms to law enforcement data security standards.

In some implementations, the transmitter 168 transmits a deactivation signal to the external camera when the light source is deactivated, causing the external camera to stop recording. In some implementations, the transmitter 168 transmits a signal to the external camera that tags recorded video with metadata including device identification, timestamp, and event type. In some implementations, the activation signal transmitted by the transmitter 168 includes officer identification information retrieved from the system memory 166. In some implementations, the transmitter 168 is configured to transmit signals to multiple external cameras simultaneously. In some implementations, the predetermined amount of time after which automatic transmission occurs is different for different types of events. In some implementations, the automatic transmission is triggered by completion of a spacing verification check rather than by light source activation. In some implementations, the automatic transmission is triggered by detection of proximity to a handcuff by the distance test indicator 170. In some implementations, the transmitter 168 transmits stored evidence data to a mobile device paired with the multi-tool device 100, and the mobile device relays the stored evidence data to the centralized database or secure evidence management system. In some implementations, the transmitter 168 transmits stored evidence data directly to a cloud-based evidence management system via a cellular network connection.

The multi-tool device 100 can include a writing instrument extending from the second body end 108. The writing instrument can be disposed within the body 102 and extends outward from the second body end 108 such that a writing tip of the writing instrument is accessible at the second body end 108. The fingertip element 150 covers at least a portion of the writing instrument when coupled to the second body end 108. When the fingertip element 150 is coupled to the retention head 110 at the second body end 108, the fingertip element 150 conceals and protects the writing tip of the writing instrument from damage and from inadvertent marking of surfaces or clothing.

The retention head 110 and the fingertip element 150 are removable from the second body end 108 to expose the writing tip of the writing instrument. To access the writing instrument for use, an officer removes the fingertip element 150 from the retention head 110 and removes the retention head 110 from the second body end 108. Once the retention head 110 and the fingertip element 150 are removed, the writing tip of the writing instrument is exposed and available for writing on paper, forms, citation booklets, or other surfaces. After use of the writing instrument, the retention head 110 is reattached to the second body end 108 and the fingertip element 150 is recoupled to the retention head 110 to cover and protect the writing tip.

In some implementations, the writing instrument comprises a pen. The pen includes an ink reservoir disposed within the body 102 and a ballpoint tip or rollerball tip at the writing tip. The ink reservoir stores ink that is dispensed through the writing tip when the writing tip is pressed against a writing surface and moved across the surface.

In some implementations, the writing instrument comprises a pencil instead of a pen. In some implementations, the pencil includes a graphite core or a mechanical pencil mechanism with replaceable lead. In some implementations, the writing instrument comprises a stylus configured for use with touchscreen devices. In some implementations, the writing instrument is retractable into the body 102 when not in use. In some implementations, the writing instrument includes a cap that covers the writing tip when the retention head 110 and fingertip element 150 are removed, wherein the cap is removable to expose the writing tip for use. In some implementations, the writing instrument is replaceable such that a depleted pen or pencil is removed from the body 102 and a new pen or pencil is inserted into the body 102. In some implementations, the ink reservoir of the pen is refillable. In some implementations, the writing instrument extends from the first body end 106 instead of the second body end 108. In some implementations, the fingertip element 150 is configured to cover the writing tip when coupled to the first body end 106. In some implementations, the multi-tool device 100 includes multiple writing instruments, such as a pen extending from the second body end 108 and a stylus extending from the first body end 106.

Referring to FIG. 9, the multi-tool device 100 includes a distance test indicator 170 positioned within the body 102 near the second body end 108. The distance test indicator 170 is configured to detect proximity to a handcuff or other object and to generate a distance input. The controller 164 receives the distance input from the distance test indicator 170, compares the distance input to a predetermined distance threshold, and generates a distance signal if the distance input is above the predetermined distance threshold. The transmitter 168 is configured to transmit the distance signal externally from the device 100.

With continued reference to FIG. 9, the distance signal is encrypted prior to transmission by the transmitter 168. The controller 164 encrypts the distance signal using an encryption protocol stored in the system memory 166. The encryption protocol prevents interception or tampering of the distance signal during wireless transmission from the multi-tool device 100 to external devices such as handcuffs equipped with sensors, paired mobile devices, or centralized databases. The encryption protocol conforms to law enforcement data security standards to ensure that the distance signal remains secure and authentic during transmission and storage.

As further shown in FIG. 9, the distance signal includes a timestamp. The controller 164 generates the timestamp at the time the distance signal is generated. The timestamp records the date and time at which the distance test indicator 170 detected proximity and the controller 164 determined that the distance input exceeded the predetermined distance threshold. The timestamp provides a temporal record of when the spacing verification occurred, which is stored as evidence of compliance with proper handcuff application protocols.

The distance signal includes data specific to the device 100. The data specific to the device 100 includes a unique device identifier associated with the multi-tool device 100. The unique device identifier is stored in the system memory 166 of the controller 164. The controller 164 retrieves the unique device identifier from the system memory 166 and includes the unique device identifier in the distance signal when the distance signal is generated. The unique device identifier links the distance signal to the specific multi-tool device 100 that performed the spacing verification. The sensors in the handcuffs or the receiving system link the data to the unique identifier associated with the verification device, thereby creating a record that associates the verification event with the specific multi-tool device 100 used by the officer.

With continued reference to FIG. 9, the distance test indicator 170 comprises a Near Field Communication (NFC) module configured to emit a proximity signal. The NFC module includes an encryption protocol to prevent unauthorized activation or duplication of the verification signal. The encryption protocol of the NFC module ensures that the proximity signal emitted by the NFC module is authenticated and cannot be replicated by unauthorized devices. The encryption protocol prevents unauthorized devices from activating handcuff sensors or generating false verification records. The encryption protocol of the NFC module uses cryptographic keys stored in the system memory 166 of the controller 164 to encrypt the proximity signal prior to emission.

In some implementations, the encryption protocol uses symmetric key encryption in which the multi-tool device 100 and the receiving system share a common cryptographic key. In some implementations, the encryption protocol uses asymmetric key encryption in which the multi-tool device 100 encrypts the distance signal using a private key and the receiving system decrypts the distance signal using a corresponding public key. In some implementations, the encryption protocol uses a rolling code mechanism in which the cryptographic key changes with each transmission to prevent replay attacks. In some implementations, the unique device identifier comprises a serial number assigned to the multi-tool device 100 during manufacturing. In some implementations, the unique device identifier comprises a digital certificate stored in the system memory 166. In some implementations, the data specific to the device 100 includes officer identification information in addition to the unique device identifier. In some implementations, the data specific to the device 100 includes geographical location data captured by a GPS module at the time the distance signal is generated. In some implementations, the timestamp is synchronized with a network time server to ensure accuracy across multiple devices and systems. In some implementations, the distance signal includes a confirmation code indicating that the handcuffs were double-locked at the time of verification.

Referring to FIG. 9, the multi-tool device 100 includes a pressure sensor 172 disposed within the fingertip element 150. The pressure sensor 172 is configured to detect pressure applied to the fingertip element 150 when the fingertip element 150 is inserted between a detainee's wrist and a handcuff. The pressure sensor 172 generates a pressure signal that is transmitted to the controller 164. The controller 164 receives the pressure signal and compares the pressure signal to a predetermined pressure threshold to determine whether the handcuffs are too tight on the detainee's wrist. The pressure sensor 172 provides objective measurement data regarding handcuff fitment that supplements the physical spacing verification performed by the fingertip element 150.

With continued reference to FIG. 9, the multi-tool device 100 includes an oxygen saturation sensor 174 disposed within the fingertip element 150. The oxygen saturation sensor 174 is configured to measure blood oxygen saturation levels of a detainee when the fingertip element 150 is positioned adjacent to the detainee's skin. The oxygen saturation sensor 174 uses optical measurement techniques to detect oxygen saturation in blood flowing through tissue near the surface of the detainee's wrist. The oxygen saturation sensor 174 generates an oxygen saturation signal that is transmitted to the controller 164. The controller 164 receives the oxygen saturation signal and stores the oxygen saturation data in the system memory 166 as part of the evidence record for the detention event.

As further shown in FIG. 9, the multi-tool device 100 includes a pulse sensor 176 disposed within the fingertip element 150. The pulse sensor 176 is configured to detect the pulse rate of a detainee when the fingertip element 150 is positioned adjacent to the detainee's skin. The pulse sensor 176 detects variations in blood flow corresponding to heartbeats and generates a pulse signal that is transmitted to the controller 164. The controller 164 receives the pulse signal and calculates a pulse rate from the detected variations. The pulse rate data is stored in the system memory 166 as part of the evidence record for the detention event.

With continued reference to FIG. 9, the pressure sensor 172, the oxygen saturation sensor 174, and the pulse sensor 176 are positioned within the fingertip element 150 such that the sensors contact or are positioned adjacent to the detainee's skin when the fingertip element 150 is inserted between the detainee's wrist and the handcuff. The positioning of the sensors within the fingertip element 150 allows the multi-tool device 100 to capture biometric and health data from the detainee during the spacing verification procedure without requiring additional steps or separate measurement devices.

The controller 164 processes data received from the pressure sensor 172, the oxygen saturation sensor 174, and the pulse sensor 176 and stores the processed data in the system memory 166. The transmitter 168 transmits the stored biometric and health data to a paired mobile device, a centralized database, or a secure evidence management system. The transmitted data provides a record of the detainee's vital signs at the time of handcuff application, which serves as evidence of the detainee's physical condition during the detention event.

The multi-tool device 100 detects double lock status from sensors embedded in the handcuffs. The distance test indicator 170 communicates with sensors embedded in the handcuffs to receive data indicating whether the handcuffs are in a double locked configuration. The controller 164 receives the double lock status data from the distance test indicator 170 and stores the double lock status data in the system memory 166. The stored evidence data includes a confirmation code indicating that the handcuffs were double-locked at the time of verification. The double lock status detection provides documentation that the officer followed proper handcuff application protocols by engaging the double lock mechanism.

In some implementations, the fingertip element 150 includes a distance sensor configured to measure the distance between the detainee's wrist and the inner surface of the handcuff. In some implementations, the fingertip element 150 includes a temperature sensor configured to measure skin temperature of the detainee. In some implementations, the oxygen saturation sensor 174 and the pulse sensor 176 are combined into a single pulse oximeter unit disposed within the fingertip element 150. In some implementations, the biometric and health sensors are disposed within the retention head 110 rather than within the fingertip element 150. In some implementations, the biometric and health sensors are disposed within both the retention head 110 and the fingertip element 150. In some implementations, the controller 164 compares the detected vital signs to predetermined threshold values and generates an alert if the detected vital signs fall outside acceptable ranges. In some implementations, the alert is provided as audible feedback, visual feedback, or haptic feedback to the officer. In some implementations, the biometric and health data is transmitted in real time to a remote monitoring station. In some implementations, the multi-tool device 100 includes a display screen that shows the detected vital signs to the officer. In some implementations, the fingertip element 150 is replaceable with different fingertip elements 150 having different sensor configurations. In some implementations, the fingertip element 150 includes electrodes configured to detect electrocardiogram signals from the detainee.

The multi-tool device 100 interacts with handcuffs equipped with sensors to record evidence of proper handcuff application. When the distance test indicator 170 of the multi-tool device 100 is brought within a predefined range of the handcuffs, the handcuff sensors detect the proximity signal emitted by the distance test indicator 170. The handcuff sensors detect and confirm the presence of the multi-tool device 100 based on the emitted proximity signal. The handcuff sensors are configured to capture data related to the use of the multi-tool device 100 once the multi-tool device 100 is detected.

The handcuff sensors record a timestamp of the verification. The timestamp records the date and time at which the handcuff sensors detected the proximity signal from the multi-tool device 100 and confirmed proper spacing verification. The timestamp provides a temporal record that documents when the officer performed the spacing verification procedure on the detainee.

The handcuff sensors store a confirmation code indicating that the handcuffs were double-locked at the time of verification. The confirmation code is generated by the handcuff sensors based on detection of the double lock status of the handcuffs at the moment the proximity signal is received from the multi-tool device 100. The confirmation code provides documentation that the officer engaged the double lock mechanism of the handcuffs in accordance with proper handcuff application protocols. The stored evidence includes the confirmation code along with the timestamp to create a complete record of the verification event.

The handcuffs include visual or auditory feedback that is activated by the detection of the NFC signal. When the handcuff sensors detect the proximity signal emitted by the NFC module of the multi-tool device 100, the handcuffs activate a visual indicator, an auditory indicator, or both. The visual indicator comprises a light-emitting diode or other light source disposed within the handcuffs that illuminates upon detection of the NFC signal. The auditory indicator comprises a speaker or buzzer disposed within the handcuffs that emits a tone or beep upon detection of the NFC signal. The visual or auditory feedback indicates successful verification of proper spacing to the officer. The feedback confirms to the officer that the multi-tool device 100 was detected by the handcuff sensors and that the verification data was captured and stored.

The stored evidence data is transmitted wirelessly from the handcuff sensors to a paired mobile device or centralized database. The handcuffs include a wireless transmitter configured to transmit the stored evidence data to external devices. The wireless transmitter of the handcuffs transmits the stored evidence data using a wireless communication protocol compatible with law enforcement mobile devices and database systems. The paired mobile device receives the stored evidence data from the handcuffs and stores the data locally or relays the data to a centralized database for long-term storage and retrieval.

The stored evidence data is transmitted wirelessly from the handcuff sensors to a secure evidence management system. The secure evidence management system receives the stored evidence data from the handcuffs and stores the data in a secure repository accessible to authorized law enforcement personnel. The secure evidence management system maintains chain of custody records for the stored evidence data and provides access controls to prevent unauthorized modification or deletion of the data. The stored evidence data transmitted to the secure evidence management system includes the timestamp, the confirmation code indicating double-lock status, and the unique identifier of the multi-tool device 100 that performed the verification.

In some implementations, the stored evidence data is transmitted wirelessly from the handcuff sensors to a paired mobile device, and the paired mobile device transmits the stored evidence data to the secure evidence management system. In some implementations, the stored evidence data is transmitted directly from the handcuff sensors to the secure evidence management system without routing through a paired mobile device. In some implementations, the stored evidence data is transmitted to both a paired mobile device and a centralized database simultaneously. In some implementations, the handcuffs store the evidence data locally until a wireless connection to a paired mobile device or centralized database is available, at which point the stored evidence data is transmitted automatically. In some implementations, the wireless transmission of stored evidence data from the handcuffs is encrypted to prevent interception or tampering during transmission. In some implementations, the handcuffs include a cellular modem configured to transmit the stored evidence data directly to a cloud-based evidence management system. In some implementations, the visual feedback comprises a multi-color light-emitting diode that displays different colors to indicate different verification statuses, such as green for successful verification and red for unsuccessful verification. In some implementations, the auditory feedback comprises different tones or tone patterns to indicate different verification statuses. In some implementations, the handcuffs include haptic feedback in addition to or instead of visual or auditory feedback. In some implementations, the handcuff sensors link the stored evidence data to a unique identifier associated with the officer who applied the handcuffs in addition to the unique identifier of the multi-tool device 100. In some implementations, the handcuff sensors capture geographical location data at the time of verification and include the geographical location data in the stored evidence data. In some implementations, the handcuff sensors capture biometric data from the detainee and include the biometric data in the stored evidence data.

The multi-tool device 100 operates through coordinated interaction of the handcuff lock tool 130, the fingertip element 150, the light source, the distance test indicator 170, the controller 164, and the transmitter 168 to perform law enforcement functions and generate evidence records.

To enforce minimum spacing standards between a detainee's wrist and a handcuff, an officer inserts the fingertip element 150 between the detainee's wrist and the closed handcuff. The fingertip element 150 acts as a physical spacer with predefined dimensions that correspond to a minimum acceptable spacing between the detainee's wrist and the inner surface of the handcuff. When the fingertip element 150 fits between the detainee's wrist and the handcuff, the handcuffs are at or above the minimum spacing standard. When the fingertip element 150 does not fit between the detainee's wrist and the handcuff, the handcuffs are below the minimum spacing standard and are too tight. The officer loosens the handcuffs and repeats the spacing verification procedure until the fingertip element 150 fits between the detainee's wrist and the handcuff.

During insertion of the fingertip element 150, the distance test indicator 170 detects proximity to the handcuff and generates a distance input. The controller 164 receives the distance input from the distance test indicator 170 and compares the distance input to a predetermined distance threshold. When the distance input is above the predetermined distance threshold, the controller 164 generates a distance signal indicating successful spacing verification. The controller 164 causes the multi-tool device 100 to provide visual feedback, audible feedback, or haptic feedback to the officer upon successful verification. The visual feedback is provided by the light source or by an indicator light. The audible feedback is provided by the speaker 178 or audio output device. The haptic feedback is provided by a vibration motor.

To rotate the lock tool 130 between the key position and the lock tip position, an officer moves the slider 148 coupled to the spring-pin. Moving the slider 148 causes the spring-pin to move from the locked position toward the unlocked position, disengaging the spring-pin from the detent 146. With the spring-pin disengaged from the detent 146, the lock tool 130 rotates freely about the pivot pin 139. The officer rotates the lock tool 130 until the handcuff key 132 or the double lock tip 134 extends away from the first body end 106 as needed for the task. When the officer releases the slider 148, the spring-pin is biased back toward the locked position by the compression spring 142. The spring-pin engages the detent 146 corresponding to the new rotational position of the lock tool 130, retaining the lock tool 130 in the selected position.

When the lock tool 130 is in the key position, the handcuff key 132 extends away from the first body end 106 and the double lock tip 134 is disposed within the body 102. The officer uses the handcuff key 132 to engage the locking mechanism of the handcuffs and move the handcuffs from a locked configuration to an unlocked configuration. When the lock tool 130 is in the lock tip position, the double lock tip 134 extends away from the first body end 106 and the handcuff key 132 is disposed within the body 102. The officer uses the double lock tip 134 to engage the double locking mechanism of the handcuffs and move the handcuffs from a double locked configuration to a double unlocked configuration.

To activate the light source for illumination and sobriety testing, an officer presses the light control button 182 on the body 102 of the multi-tool device 100. Pressing the light control button 182 causes the controller 164 to activate the light source. The light source emits light through the fingertip element 150, providing illumination at the distal end of the multi-tool device 100. The officer uses the illumination for close-range tasks such as checking handcuff fitment in low-light conditions, reading documents, or examining subjects.

Upon activation of the light source, the controller 164 logs the activation event with a timestamp and geographical location data captured by the GPS module. The controller 164 continues to log movement of the multi-tool device 100 while the light source is activated. When the officer deactivates the light source by pressing the light control button 182, the controller 164 logs the deactivation event with a timestamp and geographical location data. The controller 164 stores the logged events in the system memory 166.

Upon activation of the light source, the transmitter 168 transmits an activation signal to an external camera such as a body-worn camera or a dashboard camera. The activation signal causes the external camera to initiate recording of video and audio. The automatic initiation of recording upon light source activation documents field sobriety tests and other interactions without requiring the officer to manually activate the recording device.

The controller 164 causes the transmitter 168 to transmit the logged events to a remote server or storage device. The transmitted data includes activation events, deactivation events, movement data, timestamps, and geographical location data. The transmitted data is analyzed to generate evidence reports for use in legal or administrative proceedings. The evidence reports document the time, location, duration, and movement patterns associated with use of the light source during field sobriety testing and other law enforcement activities. The evidence reports provide objective records that support or corroborate officer testimony regarding interactions with subjects.

In some implementations, the controller 164 transmits logged events to the remote server in real time during light source activation rather than after deactivation. In some implementations, the controller 164 encrypts the logged events prior to transmission to prevent interception or tampering. In some implementations, the evidence reports are generated automatically by the remote server upon receipt of the transmitted data. In some implementations, the evidence reports are generated by law enforcement personnel using software that retrieves and formats the transmitted data. In some implementations, the evidence reports include video and audio recordings from the external camera synchronized with the logged events from the multi-tool device 100. In some implementations, the evidence reports include biometric data captured by sensors in the fingertip element 150 during spacing verification procedures. In some implementations, the evidence reports include double lock status confirmation codes received from handcuff sensors. In some implementations, the evidence reports are stored in a secure evidence management system with access controls and chain of custody tracking. In some implementations, the evidence reports are transmitted to prosecutors, defense attorneys, or courts as part of legal discovery processes. In some implementations, the evidence reports are used in administrative proceedings such as internal affairs investigations or policy compliance audits.

A number of example implementations are provided herein. However, it is understood that various modifications can be made without departing from the spirit and scope of the disclosure herein. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. Although the terms “comprising” and “including” have been used herein to describe various implementations, the terms “consisting essentially of” and “consisting of” can be used in place of “comprising” and “including” to provide for more specific implementations and are also disclosed.

Disclosed are materials, systems, devices, methods, compositions, and components that can be used for, can be used in conjunction with, can be used in preparation for, or are products of the disclosed methods, systems, and devices. These and other components are disclosed herein, and it is understood that when combinations, subsets, interactions, groups, etc. of these components are disclosed that while specific reference of each various individual and collective combinations and permutations of these components may not be explicitly disclosed, each is specifically contemplated and described herein. For example, if a device is disclosed and discussed each and every combination and permutation of the device are disclosed herein, and the modifications that are possible are specifically contemplated unless specifically indicated to the contrary. Likewise, any subset or combination of these is also specifically contemplated and disclosed. This concept applies to all aspects of this disclosure including, but not limited to, steps in methods using the disclosed systems or devices. Thus, if there are a variety of additional steps that can be performed, it is understood that each of these additional steps can be performed with any specific method steps or combination of method steps of the disclosed methods, and that each such combination or subset of combinations is specifically contemplated and should be considered disclosed.

What is claimed is:

1. A multi-tool device for use in law enforcement, the device comprising:
a body having a longitudinal axis, a first body end, and a second body end opposite and spaced apart along the longitudinal axis from the first body end;
a handcuff lock tool coupled to the first body end, wherein the lock tool comprises a handcuff key; and
a fingertip element coupled to one of the first body end or the second body end.

2. The device of claim 1, wherein the handcuff lock tool is rotationally coupled to the first body end, wherein the handcuff lock tool includes a first lock end and a second lock end opposite and spaced apart from the first lock end, wherein the handcuff key is coupled to the first lock end and a double lock tip is coupled to the second lock end, wherein the handcuff lock tool is rotatable between a key position and a lock tip position, wherein the handcuff key extends away from the first body end and the double lock tip is disposed within the body in the key position, wherein the double lock tip extends away from the first body end and the handcuff key is disposed within the body in the lock tip position.

3. The device of claim 2, further comprising a locking mechanism comprising a spring-pin and at least one detent defined by the handcuff lock tool, wherein locking mechanism is biased toward a locked position in which the spring-pin engages the at least one detent and is urgable toward an unlocked position in which the spring-pin is not engaged with the at least one detent.

4. The device of claim 3, wherein the locking mechanism includes a slider coupled to the spring pin and extending outwardly from a side of the body, wherein the slider is movable to cause the spring-pin to move from the locked position toward the unlocked position.

5. The device of claim 3, further comprising an axel about which the handcuff lock tool is rotatable relative to the body, wherein the at least one detent is defined by a portion of the axel.

6. The device of claim 3, wherein the at least one detent comprises two detents.

7. The device of claim 1, wherein the fingertip element is coupled to the second body end.

8. The device of claim 7, wherein the fingertip element is removably coupled to the second body end.

9. The device of claim 7, further comprising a light source configured to emit light through the fingertip element.

10. The device of claim 9, wherein the light source is configured to emit light at 10 lumens or less.

11. The device of claim 9, wherein the light source is configured to emit light in a strobing pattern.

12. The device of claim 9, further comprising a transmitter, wherein activation of the light source transmits a signal configured to cause a camera external to the device to initiate recording.

13. The device of claim 1, further comprising a writing instrument extending from the second body end such that the fingertip element covers at least a portion of the writing instrument when coupled to the second body end.

14. The device of claim 1, further comprising a distance test indicator.

15. The device of claim 14, wherein the distance test indicator comprises a hall effect sensor or a magnet.

16. The device of claim 14, wherein the distance test indicator comprises a Near Field Communication (NFC) module configured to emit a proximity signal.

17. The device of claim 14, further comprising a controller having a processor and a system memory, the processor being in operative communication with the distance test indicator, wherein the processor executes computer-readable instructions stored on the system memory, the instructions causing the processor to:
cause the system memory to receive a distance input from the distance test indicator,
compare the distance input to a predetermined distance threshold; and
generate a distance signal if the distance input is above the predetermined distance threshold.

18. The device of claim 17, wherein the instructions further cause the processor to:
cause the device to provide a visual feedback, an audible feedback, or a haptic feedback.

19. The device of claim 17, further comprising a transmitter configured to transmit the distance signal externally from the device.

20. The device of claim 19, wherein the distance signal is encrypted.

21. The device of claim 19, wherein the distance signal includes a timestamp or data specific to the device.

22. The device of claim 1, further comprising a pressure sensor, an oxygen saturation sensor, or a pulse sensor.

23. The device of claim 1, wherein the fingertip element is removably coupled to the first body end such that the fingertip element covers at least a portion of the handcuff lock tool when coupled to the first body end.

24. The device of claim 1, further comprising a double lock tip extending from the body.
